(19) United States
(12) Patent Application Publication
(10) Pub. No.: US 2022/0210140 A1
(43) Pub. Date: Jun. 30, 2022

(54) SYSTEMS AND METHODS FOR FEDERATED LEARNING ON BLOCKCHAIN

(71) Applicant: ATB FINANCIAL, Edmonton (CA)

(72) Inventors: Nav DHUNAY, Calgary (CA); Saeed El Khair NUSRI, Calgary (CA); Nikoo SABZEVAR, Calgary (CA)

(21) Appl. No.: 17/560,903

(22) Filed: Dec. 23, 2021

Related U.S. Application Data
(60) Provisional application No. 63/131,995, filed on Dec. 30, 2020.

(51) Int. Cl. H04L 9/40; H04L 9/00; G06N 20/00

(52) U.S. Cl. CPC H04L 63/0471; H04L 9/008; H04L 2209/38; H04L 63/0442; G06N 20/00

(57) ABSTRACT

Systems, devices, and methods for disclosed for federated learning in a network of nodes. The nodes include an aggregator node interconnected with a plurality of client nodes. Each client node performs local model training to generate locally trained model parameter values and the aggregator node aggregates the locally trained model parameter values to compute global model parameter values.

### CROSS-REFERENCE TO RELATED APPLICATIONS

This application claims all benefit, including priority of U.S. Provisional Patent Application No. 63/131,995, filed Dec. 30, 2020, the entire contents of which are incorporated herein by reference.

### FIELD

This disclosure relates to machine learning, and more particularly to federated learning.

### BACKGROUND

Federated learning (also known as collaborative learning) is a machine learning technique that trains an algorithm across multiple decentralized edge devices or servers holding local data samples, without exchanging them.

### SUMMARY

In accordance with an aspect, there is provided a computer-implemented method for federated learning in a network of nodes. The method includes, at an aggregator node of the network of nodes: generating a payload data structure defining initial parameter values of a model to be trained by way of federated learning; identifying a target node from among a pool of nodes for receiving the payload data structure; providing the payload data structure to the target node; receiving an updated payload data structure from a node other than the target node, the payload data structure including locally trained model parameter values updated by a plurality of client nodes, the model parameter values encrypted using a public key of the aggregator node; decrypting the locally trained model parameter values using a private key corresponding to the public key; and generating global model parameter values based on the decrypted locally trained model parameter values.

In accordance with another aspect, there is provided an aggregator node in a federated learning network. The aggregator node includes at least one processor; memory in communication with the at least one processor, and software code stored in the memory, which when executed by the at least one processor causes the aggregator node to: generate a payload data structure defining initial parameter values of a model to be trained by way of federated learning; identify a target node from among a pool of nodes for receiving the payload data structure; provide the payload data structure to the target node; receive an updated payload data structure from a node other than the target node, the payload data structure including locally trained model parameter values updated by a plurality of client nodes, the model parameter values encrypted using a public key of the aggregator node; decrypt the locally trained model parameter values using a private key corresponding to the public key; and generate global model parameter values based on the decrypted locally trained model parameter values.

In accordance with another aspect, there is provided a computer-implemented method for federated learning in a network of nodes. The method includes, at a given client node of the network of nodes: receiving a payload data structure including locally trained model parameter values updated by at least one other client node, the model parameter values encrypted by a public key of an aggregator node of the network of nodes; performing local model training using training data available at the given client node to compute further model parameter values; encrypting the further model parameter values using the public key; updating the locally trained model parameter values to incorporate the further model parameter values; and providing the updated model parameter values to another node of the network of nodes.

In accordance with another aspect, there is provided a client node in a federated learning network. The client node includes: at least one processor; memory in communication with the at least one processor, and software code stored in the memory, which when executed by the at least one processor causes the client node to: receive a payload data structure including locally trained model parameter values updated by at least one other client node, the model parameter values encrypted by a public key of an aggregator node of the network of nodes; perform local model training using training data available at the given client node to compute further model parameter values; encrypt the further model parameter values using the public key; update the locally trained model parameter values to incorporate the further model parameter values; and provide the updated model parameter values to another node of the network of nodes.

Many further features and combinations thereof concerning embodiments described herein will appear to those skilled in the art following a reading of the instant disclosure.

### BRIEF DESCRIPTION OF THE DRAWINGS

In the figures,

FIG. 1 is a network diagram of a network environment for a federated learning system, in accordance with an embodiment;

FIG. 2 is a high-level schematic diagram of an aggregator node of the federated learning system of FIG. 1, in accordance with an embodiment;

FIG. 3 is a high-level schematic diagram of a client node of the federated learning system of FIG. 1, in accordance with an embodiment;

FIG. 4 is a workflow diagram of the federated learning system of FIG. 1, in accordance with an embodiment;

FIG. 5 is an example code listing of a public key data structure, in accordance with an embodiment;

FIG. 6 is an example code listing of a payload data structure, in accordance with an embodiment;

FIG. 7 is a sequence diagram of the federated learning system of FIG. 1, in accordance with an embodiment;

FIG. 8 is an example code listing of a model parameter data structure, in accordance with an embodiment;

FIG. 9 is a high-level schematic diagram of an aggregator node of a federated learning system, in accordance with an embodiment;

FIG. 10 is a high-level schematic diagram of a client node of a federated learning system, in accordance with an embodiment;

FIG. 11 is an architectural diagram of a federated learning system in accordance with an embodiment; and

FIG. 12 is a schematic diagram of a computing device, in accordance with an embodiment.

These drawings depict exemplary embodiments for illustrative purposes, and variations, alternative configurations, alternative components and modifications may be made to these exemplary embodiments.

### DETAILED DESCRIPTION

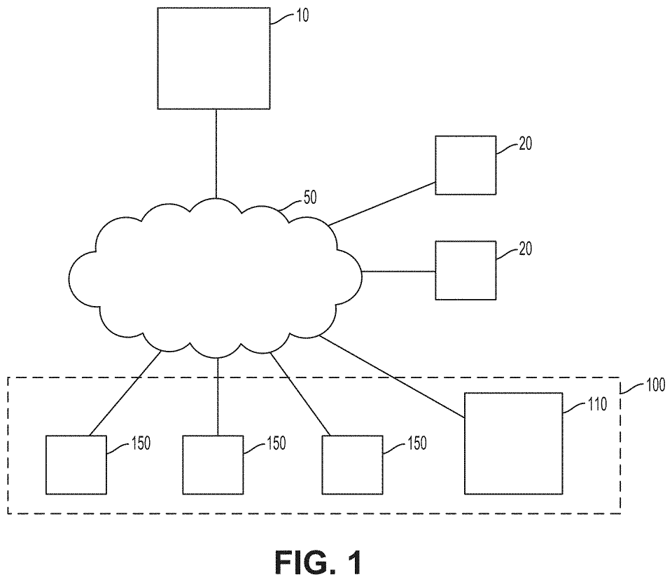

FIG. 1 is a network diagram showing a network environment of a federated learning system 100, in accordance with an embodiment. As detailed herein, federated learning system 100 is blockchain-based and enables models to be trained via the blockchain in a decentralized manner. For example, by utilizing a consensus mechanism in blockchain, training can be performed without requiring transmission of training data to a centralized location.

In some embodiments, the blockchain may be a self-sovereign identity (SSI) blockchain and utilize decentralized identifiers for communication between nodes of federated learning system 100. Such decentralized identifiers may conform, for example, with the Decentralized Identifiers (DIDs) standard established by the World Wide Web Consortium. DIDs are globally unique cryptographically-generated identifiers that do not require a registration authority and facilitate ecosystems of self-sovereign identity. In particular, a DID can be self-registered with the identity owner's choice of a DID-compatible blockchain, distributed ledger, or decentralized protocol so no central registration authority is required.

As shown in FIG. 1, federated learning system 100 includes an aggregator node 110 and a plurality of client nodes 150. As detailed herein, aggregator node 110 manages training cycles and aggregates model parameter updates generated at client nodes 150. Each client node 150 performs model training using training data available at that node 150, and shares data reflective of trained model parameters with other nodes in manners disclosed herein.

In the depicted embodiment, nodes of federated learning system 100 are interconnected with one another and with trust organization server 10 and blockchain devices 20 by way of a network 50.

Trust organization server 10 issues a DID to each node in federated learning system 100. Trust organization server 10 may issue a DID to a node upon verifying credentials of an operator of the node or a device implementing the node, e.g., to ensure that such nodes are trusted entities within federated learning system 100.

In some embodiments, trust organization server 10 may implement the Decentralized Key Management System provided as part of the Hyperledger Aries framework to verify entities and issue DIDs to verified entities.

Blockchain devices 20 are devices that function as nodes of a blockchain or other type of distributed ledger or distributed protocol used for communication between and among aggregator node 110 and client nodes 150. In some embodiments, a blockchain device 20 may function as a node of a public blockchain network such as the Sovrin network, the Uport network, the Bedrock network, the Ethereum network, the Bitcoin network, or the like. In some embodiments, a blockchain device 40 may function as node of a private blockchain network.

Network 50 may include a packet-switched network portion, a circuit-switched network portion, or a combination thereof. Network 50 may include wired links, wireless links such as radio-frequency links or satellite links, or a combination thereof. Network 50 may include wired access points and wireless access points. Portions of network 50 could be, for example, an IPv4, IPv6, X.25, IPX or similar network. Portions of network 50 could be, for example, a GSM, GPRS, 3G, LTE or similar wireless networks. Network 50 may include or be connected to the Internet. When network 50 is a public network such as the public Internet, it may be secured as a virtual private network.

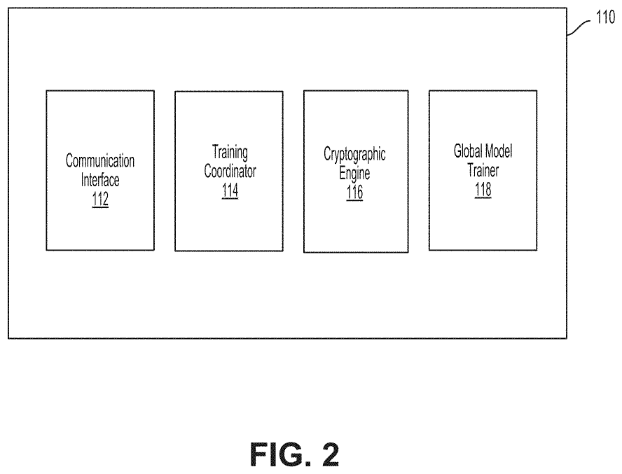

FIG. 2 is a high-level schematic of aggregator node 110, in accordance with an embodiment. As depicted, aggregator node 110 includes a communication interface 112, a training coordinator 114, a cryptographic engine 116, and a global model trainer 118.

Communication interface 112 enables aggregator node 110 to communicate with other nodes of federated learning system 100 such as client nodes 150, e.g., to send/receive payloads, model data, encryption key data, or the like. Communication interface 112 also enables aggregator node 110 to communicate with trust organization server 10, e.g., to receive DIDs therefrom.

In some embodiments, communication interface 112 uses a communication protocol based on the DIDComm standard, which facilitates the creation of secure and private communication channels across diverse systems using DID. For example, communication interface 112 may implement the DIDComm Messaging specification, as published by the Decentralized Identity Foundation.

Training coordinator 114 manages various training processes in federated learning system 100 on behalf of aggregator node 110. For example, training coordinator 114 selects client nodes 150 for participation in a training cycle (e.g., based on a pool of available nodes and corresponding DIDs provided by trust organization server 10) and is responsible for initiating each training cycle. Such initiation may, for example, include preparing an initial payload for a federated training cycle and providing the payload to a first client node 150 by way of communication interface 112. This payload may include, for example, some or all of initial model parameter values for the training cycle, data reflective of the number of client nodes expected to participate in the training cycle (e.g., a target index as described below), a public key for the aggregator node 110 generated by cryptographic engine 116 (e.g., in serialized form), and data reflective of a signal to initiate the training cycle. Initial model parameter values may correspond to a best guess of those values, or parameter values generated in a prior learning cycle.

In some embodiments, training coordinator 114 causes data defining a model to be provided to one or more client nodes 150 prior to a first training cycle. Conveniently, this allows such client nodes 150 to begin training its local model before receiving a payload.

In some embodiments, training coordinator 114 causes a public key for aggregator node 110 to be provided to one or more client nodes 150 prior to a first training cycle. Conveniently, this allows such client nodes 150 to begin encrypting model parameter data generated locally before receiving a payload.

As detailed herein, once a training cycle is initiated, the payload is processed at successive client nodes 150, e.g., to update the payload based on model training at each successive client node 150.

Each client node 150 provides an updated payload to a successive client node 150 until a final client node 150 of a training cycle is reached. The final client node 150 passes the payload back to the aggregator node 110 to update the global model.

Cryptographic engine 116 generates encryption keys allowing model parameters to be communicated between and among nodes of federated learning system 100 in encrypted form. For example, cryptographic engine 116 may generate a public-private key pair. As detailed herein, a client node 150 may use the public key to encrypt data and cryptographic engine 116 of aggregator node 110 may use the corresponding private key to decrypt the data.

In some embodiments, nodes of federated learning system 100 may implement a type of homomorphic encryption, which allows mathematical or logical operations to be performed on encrypted data (i.e., ciphertexts) without decrypting that data. The result of the operation is in an encrypted form, and when decrypted the output is the same as if the operation had been performed on the unencrypted data.

In some embodiments, nodes of federated learning system 100 may implement Pallier encryption, a type of partial homomorphy encryption that allows two types of operations on encrypted data, namely, addition of two ciphertexts and multiplication of a ciphertext by a plaintext number. In such embodiments, cryptographic engine 116 generates a public-private key pair suitable for Pallier encryption.

Conveniently, encryption of model parameter data helps to avoid interference attacks or leakage of private information, e.g., as may be reflected in the training data and model parameters. Further, the use of Pallier encryption allows, for example, multiple model parameters values to be added together by a client node 150 without first decrypting values received from another client node 150.

Global model trainer 118 processes trained model parameter data received from client nodes 150, and processes such data to train a global model that benefits from training performed at a plurality of client nodes 150. For example, global model trainer 118 may receive a payload from the last client node 150 in a training cycle, which includes data reflective of model training at each client node 150 that participated in the training cycle.

In some embodiments, such data reflective of training at each client node 150 may be an aggregation (e.g., an arithmetic sum) of model parameters computed at each client node 150. In some embodiments, such data may be decrypted by cryptographic engine 116 for further processing by global model trainer 118. During each training cycle, global model trainer 118 computes a global model update based the trained model parameter data received from client nodes 150 to obtain updated global model parameters.

In some embodiments, aggregator node 110 transmits updated global model parameters to one or more client nodes 150, e.g., by way of communication interface 112. Such updated global model parameters may be transmitted to client nodes 150 at the end of each training cycle or at the end of a final training cycle.

In the depicted embodiment, global model trainer 118 computes a global model update in the following manner, described with reference to a simplified example machine learning model.

In an example machine learning problem fᵢ(w)=l(xᵢ,yᵢ,ω), ω represents the model parameters that achieves a given loss in prediction on the example (xᵢ,yᵢ). For example, in a regression model, model parameters are the optimized coefficients of Xᵢ.

Given this machine learning problem, federated learning involves multiple participants (e.g., multiple client nodes 150) working together to solve an empirical risk minimization problem of the form:

$$min \frac{1}{K} {\sum }_{i = 1}^{K} {f}_{i} ( x )$$

where K is the number of participants in training cycle, x∈R_{d} encodes the d parameters of a global model (e.g., gradients from incremental model updates) and

fᵢ(x)=E_{ξ˜D}_{ᵢ}[f(x,ξ)]

represents the aggregate loss of model on the local data represented by distribution Dᵢ of a participant (client node) i, where Dᵢ may possess very different properties across the devices.

The depicted embodiment uses an approach to obtain optimized model parameters through Local Gradient Descent (LGD) which is an extension of gradient descent that performs multiple gradient steps at each client node 150 and then aggregation takes place at aggregator node 110 through averaging of the model parameters. This approach may be referred to as “Federated Averaging” or “FedAvg”, as described in article “Communication-efficient learning of deep networks from decentralized data”, H. Brendan McMahan et al., 2017, Proceedings of the 20th International Conference on Artificial Intelligence and Statistics, and article “Federated learning of deep networks using model averaging”, H. Brendan McMahan et al., 2016, arXiv:1602.05629. LGD may, for example, be local stochastic gradient descent.

In this approach:

ω: model parameters

Ω: Aggregated model (at aggregator node 110)

K: # of clients/participants

E: # of local epochs

η: learning-rate parameter—between 0-1

Δl(ω): Losses from Local Gradient Descent (at a client node 150)

At the beginning of a training cycle, initial parameters ωₒ are set by training coordinator 114 in the payload.

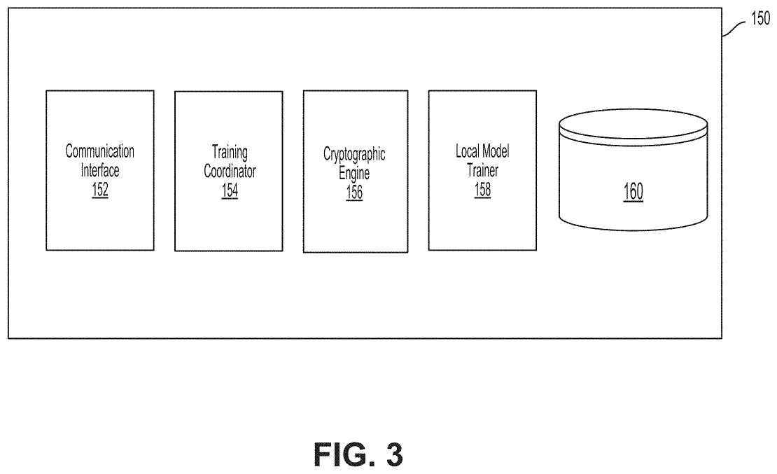

At the end of a training cycle, the payload is passed back to aggregator node 110. Model data are decrypted by cryptographic engine 116, and the decrypted data are aggregated as follows:
ωₜ₊₁^{k}←ClientUpdate(k, ωₜ)—where ClientUpdate is the local model training performed at each client node as described herein with reference to local model trainer 158 (FIG. 3); and

$${Ω}_{t + 1} ← \frac{1}{K} {\sum }_{k = 1}^{K} {ω}_{t + 1}^{k} .$$

The depicted embodiment implements FedAvg using a modified McMahan's algorithm to solve for a linear regression. McMahan's algorithm is described, for example, in “Communication-efficient learning of deep networks from decentralized data”, H Brendan McMahan et al., 2017, Proceedings of the 20th International Conference on Artificial Intelligence and Statistics.

In some embodiments, instead of FedAvg, global model trainer 118 may use another approach for training a federated deep neural network. For example, McMahan's algorithm on FedSGD on multiple cycles can be used, as described in “Federated learning of deep networks using model averaging”, H. Brendan McMahan et al., 2016, arXiv:1602.05629.

FIG. 3 is a high-level schematic of client node 150, in accordance with an embodiment. As depicted, client node 150 includes a communication interface 152, a training coordinator 154, a cryptographic engine 156, a local model trainer 158, and an electronic data store 160.

Communication interface 152 enables client node 150 to communicate with other nodes of federated learning system 100 such as aggregator node 110 and other client nodes 150, e.g., to send/receive payloads, model data, encryption key data, or the like. Communication interface 152 also enables client node 150 to communicate with trust organization server 10, e.g., to receive a DID therefrom.

In some embodiments, communication interface 152 uses a communication protocol based on the DIDComm standard. For example, communication interface 152 may implement the DIDComm Messaging specification, as published by the Decentralized Identity Foundation.

In some embodiments, communication interface 152 allows client node 150 to communicate with other nodes by way of a blockchain and allowing model parameter data to be transmitted by way of the blockchain. Conveniently, in such embodiments, there is no need for model parameter data to be sent by client nodes 150 to a centralized location.

Training coordinator 154 manages various learning processes in federated learning system 100 on behalf of a given client node 150. For example, training coordinator 154 may determine the target node to receive a payload generated at the given client node 150. The target node may be another client node 150. The target node may be determined according to a node order defined in the payload received at the given client node 150, e.g., as defined by aggregator node 110 or another client node 150. Such target node may be another client node 150 randomly selected by the given client node 150, e.g., from a pool of client nodes 150 that have not yet participated in a current training cycle. The target node may also be the aggregator node 110 when the given client node 150 determines that it is the final client node 150 in a training cycle, e.g., when a target index defined by aggregator node 110 is reached.

Cryptographic engine 156 encrypts model parameter data generated at a client node 150 for decryption at aggregator node 110. Such encryption may use a public key of aggregator node 110. Cryptographic engine 156 implements a type of encryption as utilized by cryptographic engine 116 of aggregator node 110 to maintain interoperability therewith. In some embodiments, cryptographic engine 156 implements a type of homomorphic encryption such as Pallier encryption.

Local model trainer 158 trains a local model using training data available at a given client node 150, e.g., as may be stored in electronic data store 160. In some embodiments, local model trainer 158 implements stochastic gradient descent. In some embodiments, local model trainer 158 implements the following approach training, which spans E epochs:

For each epoch i from 1 to E do

ω←ω−ηΔl/(ω).

Depending on the model, updated model parameters may include gradients or coefficients for linear regression.

After updated model parameters have been updated based on training for a current training cycle, the model parameters are encrypted by cryptographic engine 156, e.g., using a public key of aggregator node 110. When the model parameters are encrypted using Pallier encryption, local model trainer 158 arithmetically adds the local encrypted model parameters to encrypted model parameters received in the payload from prior client node 150, as follows:
Add ω to Σₖ₌₁^{k-1}ωₜ₊₁^{k-1}

The arithmetically summed model parameters are added to the payload as follows:
Return Σₖ₌₁^{k}ωₜ₊₁^{k} to the payload

Such payload may be passed to the next node in the training cycle, e.g., by communication interface 152.

Electronic data store 160 stores training data available a given client node 150. In some embodiments, such training data may be generated at the given client node 150. In some embodiments, such training data may be collected at the given client node 150 from one or more other sources.

In some embodiments, a client node 150 may be a smartphone operated by an end user, and training data be include usage data logged at the client node 150. For example, the smartphone may include a wallet application for storing digital credentials and the training data may relate to the manner and/or frequency of use of such wallet application or such digital credentials.

In some embodiments, training data may include private information or other sensitive information (e.g., health information) of the end user.

Electronic data store 160 may implement a conventional relational, object-oriented, or NoSQL database, such as Microsoft SQL Server, Oracle, DB2, Sybase, Pervasive, MongoDB, etc.

Each of communication interface 112, training coordinator 114, cryptographic engine 116, global model trainer 118, communication interface 152, training coordinator 154, cryptographic engine 156, and local model trainer 158 may be implemented using conventional programming languages such as Java, J#, C, C++, Python, C#, Perl, Visual Basic, Ruby, Scala, etc. These components of system 100 may be in the form of one or more executable programs, scripts, routines, statically/dynamically linkable libraries, or the like.

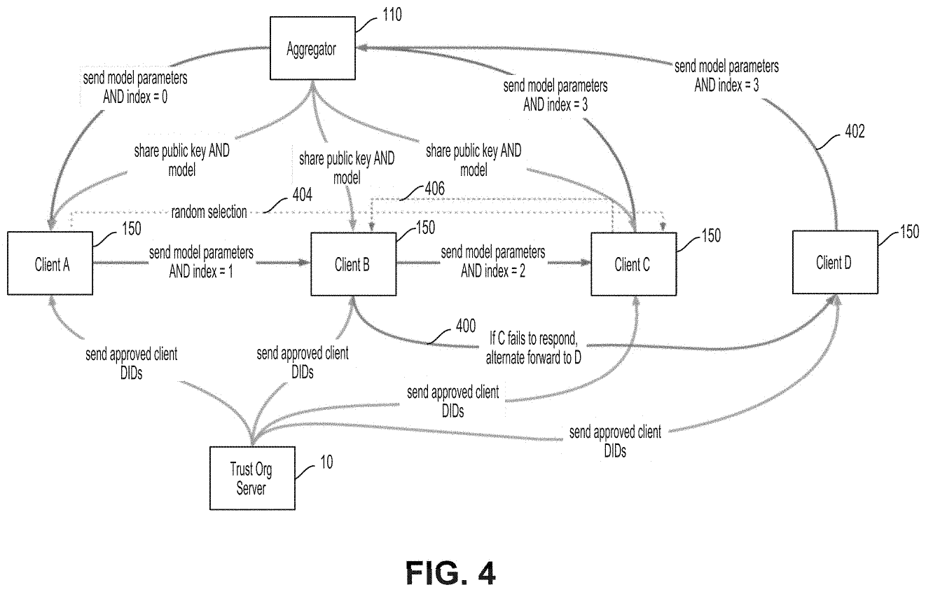

Example operation of federated learning system 100 may be further described with reference to the workflow diagram of FIG. 4, which depicts example workflow in accordance with an embodiment.

In accordance with this workflow, trust organization server 10 provides a DID to aggregator node 110 and each client node 150, e.g., upon verifying that such nodes are valid participants who have agreed to be part of a learning federation. Such DIDs allow nodes to communicate with one another by way of DIDComm. In some embodiments, another type of decentralized identifier may be used.

Trust organization server 10 provides to aggregator node 110 a list of DIDs reflecting a pool of client nodes 150 that can participate in a training cycle. Aggregator node 110 selects a desired number of participants in the training cycle and sets a target index equal reflective of this number. When the desired number is less than the size of the pool, aggregator node 110 selects the participating client nodes 150 from the pool. Such selection may be random or based on other criteria, e.g., quantity or quality of training data at particular client nodes.

In some embodiments, the particular client nodes 150 may vary from training cycle to training cycle.

Training coordinator 114 generates data defining a model and initial model parameters, and such data are provided to each client node 150 participating in the training cycle, e.g., by way of communication interface 112.

Upon receiving the model, each participating client node 150 (e.g., Clients A, B, and C in FIG. 4) begins training the local model using training data available at the respective client node 150. Such training may occur in parallel at two or more client nodes 150. Such training may overlap in time at two or more modes. Such training may use local stochastic gradient descent or another suitable approach.

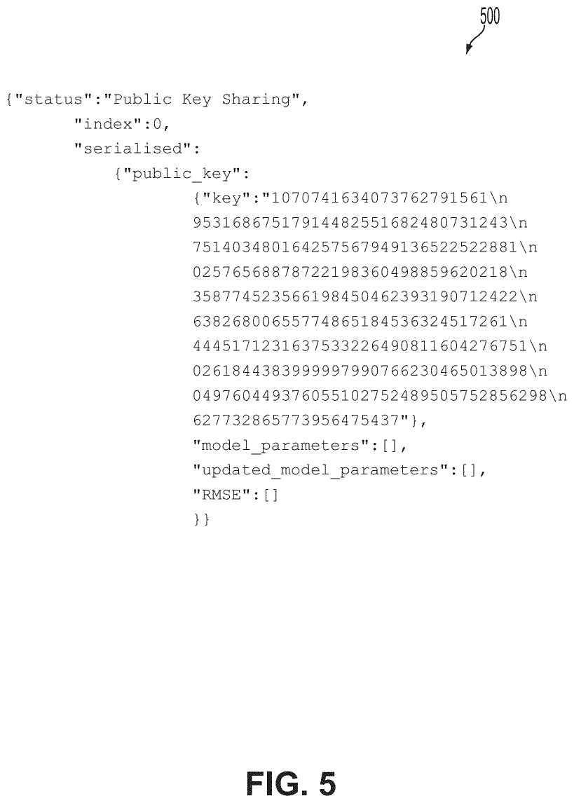

Cryptographic engine 116 of aggregator node 110 generates a private/public key pair. The private key is retained at aggregator node 110, while the public key is provided to each client node 150 participating in the training cycle, e.g., by way of communication interface 112. FIG. 5 depicts an example JSON code listing for a public key data structure 500 provided to each client node 150, which includes an example public key.

Upon receiving the public key, each participating client node 150 (e.g., Clients A, B, and C in FIG. 4) encrypts the locally trained model parameters.

Training coordinator 114 of aggregator node 110 selects a first client node 150 of the training cycle, e.g., Client A. Training coordinator 114 generates an initial payload data structure and provides this to Client A. The payload may include a target index which is a number that reflects a specified number of participating client nodes in the training cycle, and a current index reflecting the current node position within a training cycle. In this example, the target index value may be set to 3, and the current index value may be set to 0. This initial current index value indicates to Client A that it is the first client node 150 in the training cycle. The payload may also specify an ordering of client nodes 150 in the training cycle (e.g., Client A, then Client B, then Client C) which may be defined by an ordered list of DIDs for the client nodes 150.

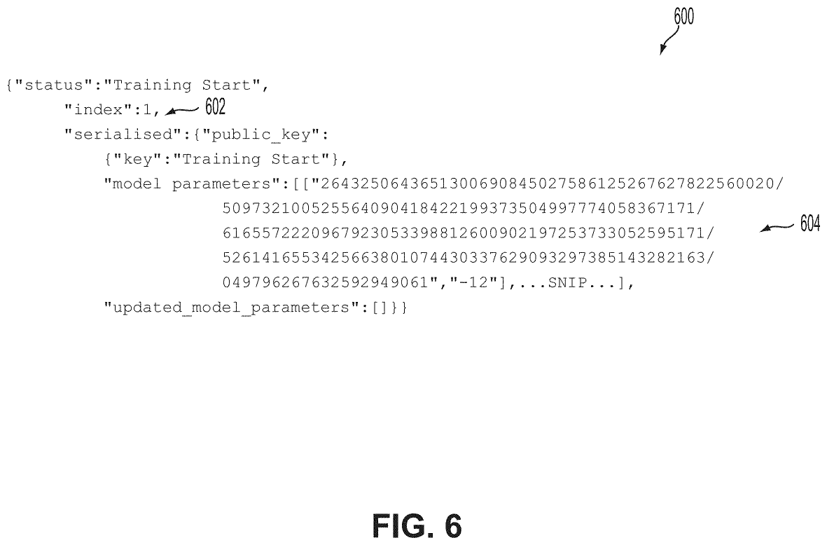

Upon receiving the payload data structure from aggregator node 110 (e.g., via communication interface 152), Client A updates the payload data structure by arithmetically adding its encrypted model parameters to the parameter values in the received payload. Client A increments the current index value by 1 (e.g., from a value of 0 to a value of 1). Client A checks the current index to determine whether the target index has been reached. As the target index has not been reached, Client A provides the updated payload data structure to next client node 150, namely, Client B. FIG. 6 depicts an example JSON code listing for an example payload data structure 600 provided by Client A to Client B. As shown, data structure 600 includes a current index value 602 and model parameters 604 updated at Client A.

Upon receiving the payload data structure from Client A (e.g., via communication interface 152), Client B updates the payload data structure by arithmetically adding its encrypted model parameters to the parameter values in the received payload. Client B increments the current index value by 1 to a value of 2. Client B checks the current index to determine whether the target index has been reached. As the target index has not been reached, Client B provides the updated payload data structure to next client node 150, namely Client C.

Upon receiving the payload data structure from Client B (e.g., via communication interface 152), Client C updates the payload data structure by arithmetically adding its encrypted model parameters to the parameter values in the received payload. Client C increments the current index value by 1 to a value of 3. Client C checks the index to determine whether the target index has been reached. In this case, the target index has been reached indicating that all client nodes 150 participating in the training cycle have updated the payload data structure. Accordingly, Client C provides the updated payload data structure to aggregator node 110.

Upon receiving the payload data structure from Client C (e.g., via communication interface 112), aggregator node 110 processes the payload data structure to update the global model. In particular, cryptographic engine 116 of aggregator node 110 decrypts the encrypted model parameters using the retained private key. Global model trainer 118 trains the global model by aggregating the decrypted model parameters, e.g., using FedAv. This concludes a training cycle.

To initiate a new training cycle, aggregator node 110 generates a new payload with model parameter values based on the updated global model parameters. This new payload is provided to Client A, and the training cycle progresses as described above.

Training cycles are repeated until the model is trained until there is a convergence to global minimum. For example, aggregator node 110, under control of training coordinator 114, may initiate new training cycles until one or more termination criteria are met. Termination criteria may include, for example, one or more of improvements to a global root-mean-square error (RMSE) value becoming negligible, the RMSE value becoming less than a pre-defined threshold, and reaching a pre-defined maximum number of cycles.

Although example data structures have been shown defined in a JSON format, such data structures could also be in another suitable format (e.g., XML. YAML, or the like).

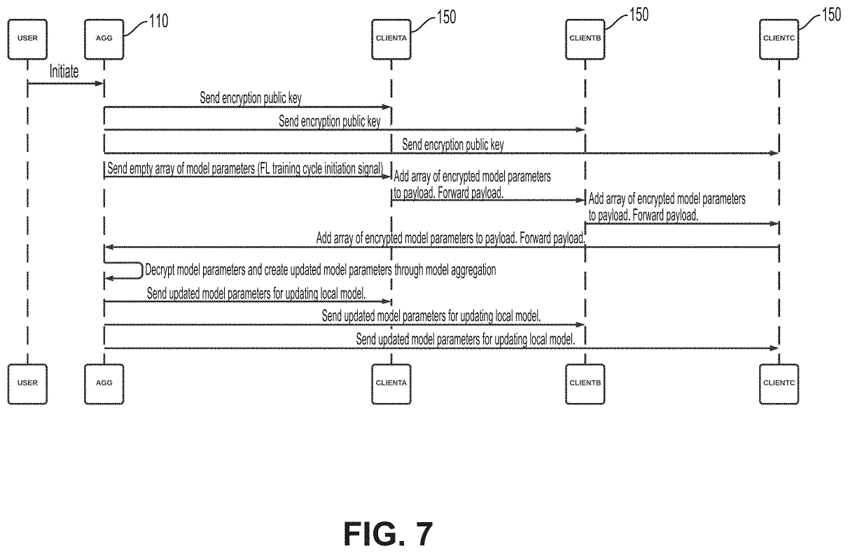

FIG. 7 is a sequence diagram showing a sequence of example operations at aggregator node 110 and client nodes 150 (i.e., Client A, Client B, and Client C), in accordance with an embodiment. As depicted, the example operations are initiated by a user (e.g., a training administrator). Once initiated, aggregator node 100 sends a public key for encryption to each of the client nodes 150. Aggregator node 100 also sends an initial model parameter (payload) data structure (e.g., which can be an empty array or an array with initial parameter values) to the first client node 150 (e.g., Client A). Each client node 150 updates the model parameter data structure and forwards it to a successful client node 150 (Client B and so on). The last client node 150 sends the model parameter data structure to aggregator 100. Aggregator 100 decrypts the data structure and processes the model parameter data structure to update a global model.

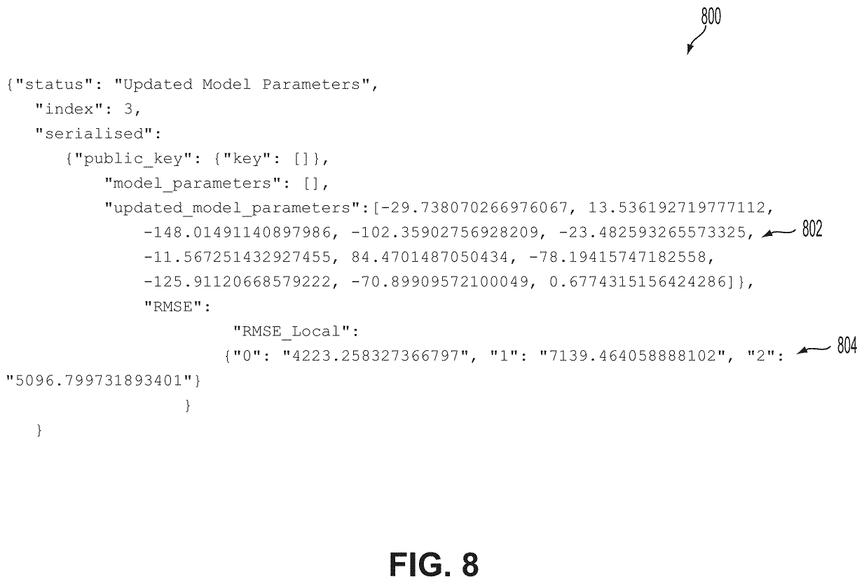

In some embodiments, once all training cycles have been completed, aggregator node 110 may provide globally trained model parameters to one or more client nodes 150. FIG. 8 depicts an example JSON code listing for an example model parameter data structure 800 provided by aggregator node 110 to client nodes 150. As shown, data structure 800 includes updated global model parameters 802 and RMSE values 804.

In some embodiments, model parameter data structure 800 is provided by aggregator node 110 to a first client node 150 (e.g., Client A), and model parameter data structure 800 is propagated sequentially from one client node 150 to the next in a similar manner as a payload data structure 600.

In some embodiments, aggregator 100 may send the globally trained model parameters to client nodes 150 in addition to or other than those that participated in the training cycle.

In the above-described example operation, three client nodes 150 participate in the training cycle. However, as will be appreciated, a training cycle can include any number of client nodes 150.

In some embodiments, a training cycle can continue in the presence of a disabled or otherwise non-responsive client node 150. For example, when a payload data structure is provided to a target client node 150, an acknowledge message may be requested. If an acknowledgement message is not received within a pre-defined time-out period, then the training cycle may be routed around the non-responsive client node 150. Referring to arrow 400 of FIG. 4, in one example, Client B provides a payload data structure to Client C, but Client C does not respond with an acknowledgement. In this circumstance, Client B provides the same payload data structure to Client D. Client D then performs the functions described above for Client B and provides its payload to aggregator node 110 (arrow 402). As will be appreciated, Client D may have different training data than Client C, and thus the resultant local and aggregated global model parameters may differ as a result of the routing to Client D.

In some embodiments, the ordering of client nodes 150 in a training cycle may differ from the ordering described above with reference to FIG. 4-FIG. 8. For example, the ordering may be randomized. Referring to arrow 404 of FIG. 4, in an example, Client A may select a random client node 150 to receive its payload. As depicted, Client A randomly selects Client C and thus provides its payload to Client C. Thereafter, Client C randomly selects Client B to receive its payload and provides its payload to Client B (arrow 406). Thereafter, Client B may determine that it is the last client node in the training cycle (e.g., based on the current index value reaching the target index value), and provide its payload to aggregator node 110. The ordering of client nodes 150 may differ from one training cycle to the next.

To facilitate random selection, the payload data structure may contain a list of DIDs for client nodes 150 and indicators of which client nodes 150 have not yet participated in a current training cycle. The list may be updated at each successive client node 150.

Random ordering of client nodes 150 in a training cycle may further protect the privacy of end users.

The operation of federated learning system 100 may be further described with reference to an example application.

In this example application, each client node 150 is a smartphone operated by an end user. The smartphone executes a wallet application storing digital credentials of that end user. In this example application, federated learning system 100 may be used to predict how frequently a given user will use the wallet application.

Table 1 shows the training data (e.g., features) used in an model for training in federated learning system 100.

TABLE 1

| | | | | | | Target |
|---|---|---|---|---|---|---|
| | # con- | # cre- | In- | In- | In- | (visit/ |
| User | nections | dentials | dustry_X | dustry_Y | dustry_Z | week) |
| i | 4 | 0 | 0 | 0 | 0 | 5.1 |
| i | 17 | 8 | 0 | 1 | 7 | 43.3 |
| i | 9 | 6 | 2 | 0 | 4 | 29.8 |

Each row of Table 1 corresponds to training data at one particular client node 150, e.g., for a user i. Each row of data may be stored in an electronic data store 160 of a respective client node 150.

These features include a number of connections made by a given end user (e.g., to verifiers or issuers of digital credentials), and the number and type of digital credentials. As shown, digital credentials are categorized into one of three industries (i.e. Industry_X—energy, Industry_Y—finance, and Industry_Z—health). Each row of Table 1 also includes a target value corresponding to the number of times the wallet application is used per week (“visits”), which is collected by the wallet application over a period of several weeks. A model is trained to predict how often the given end user will use the wallet application each week, e.g., based on a multivariate linear regression fit of the features.

As will be appreciated, data reflecting how often a wallet and its digital credentials are used and the types of those credentials may be considered private information in some jurisdictions. Accordingly, it may be desirable to avoid transmitting such information from the end user's personal device.

To protect each end user's privacy, federated learning as implemented at federated learning system 100 is applied in manners described herein. Within federated learning system 100, each client node 150 trains the model locally and provides encrypted model parameters to successive client nodes 150 and aggregator node 110. The user's data cannot be recovered even when the model parameters are decrypted.

In this example application, 50 is selected as the number of training cycles defining a termination criterion and mean squared error (MSE) is selected as the validation metric. For two participating client nodes 150, 36.55 and 38.76 are the computed MSEs, while at the global level the error decreases to 33.73. This shows an improvement in the global model accuracy for aggregator node 110 by leveraging a large set of data, distributed across multiple client nodes 150.

As will be appreciated, the model and features in the above example application have been simplified in some respects for ease of description to illustrate the operation of federated learning system 100.

Federated learning system 100 can be applied to various problem domains, e.g., whenever training data are distributed across multiple nodes.

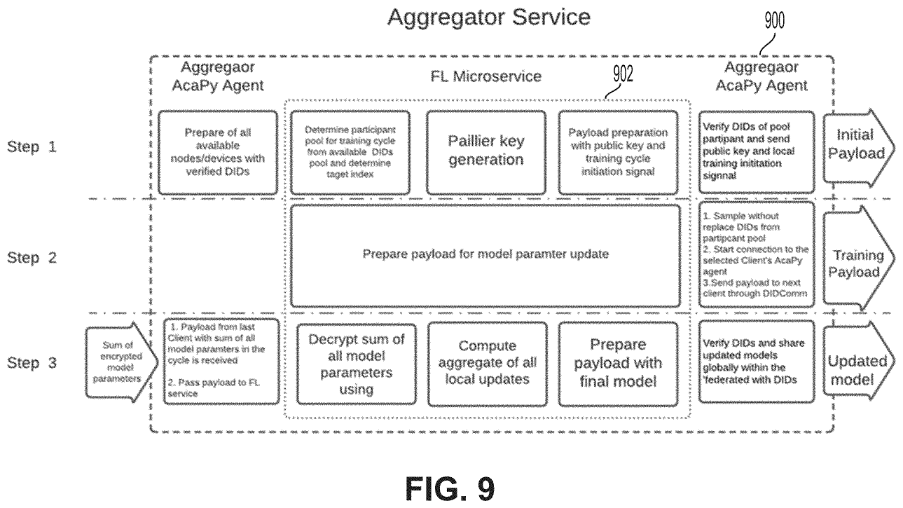

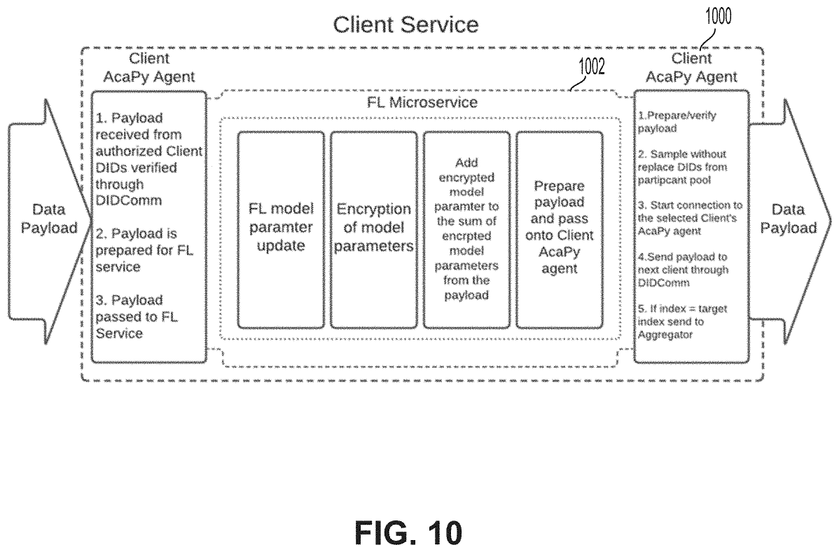

In some embodiments, federated learning system 100 implements Hyperledger Aries Cloud Agent Python (ACA-Py) to manage coordination and communication between nodes. For example, each node (aggregator node 110 and client nodes 150) may instantiate an ACA-Py agent to manage DIDComm communication with other nodes. Such embodiments implementing ACA-Py are further described with reference to FIG. 9 and FIG. 10.

FIG. 9 is a high-level schematic diagram of an aggregator node 110 with an APA-Py agent 900. As depicted, APA-Py agent 900 implements various functionality of aggregator node 110 including, e.g., functionality of communication interface 112 (e.g., sending and receiving payloads, etc.) and certain functionality of training coordinator 114 (e.g., selecting a target client node, etc.). APA-Py agent 900 includes a federated learning microservice 902. Microservice 902 implements various functionality of aggregator node 110 including, e.g., functionality of cryptographic engine 116 (e.g., generating a public-private key pair, encrypting/decrypting model data, etc.), global model trainer 118 (e.g., computing global model parameters, etc.), and certain functionality of training coordinator 114 (e.g., selecting participants for a learning cycle, setting a target index value, etc.).

FIG. 10 is a high-level schematic diagram of a client node 150 with an APA-Py agent 1000. As depicted, APA-Py agent 1000 implements various functionality of client node 150 including, e.g., functionality of communication interface 152 (e.g., sending and receiving payloads, etc.) and certain functionality of training coordinator 154 (e.g., selecting a target client node, etc.). APA-Py agent 1000 includes a federated learning microservice 1002. Microservice 1002 implements various functionality of client node 150 including, e.g., functionality of cryptographic engine 156 (e.g., encrypting model data, etc.), and local model trainer 158 (e.g., computing local model parameters, etc.).

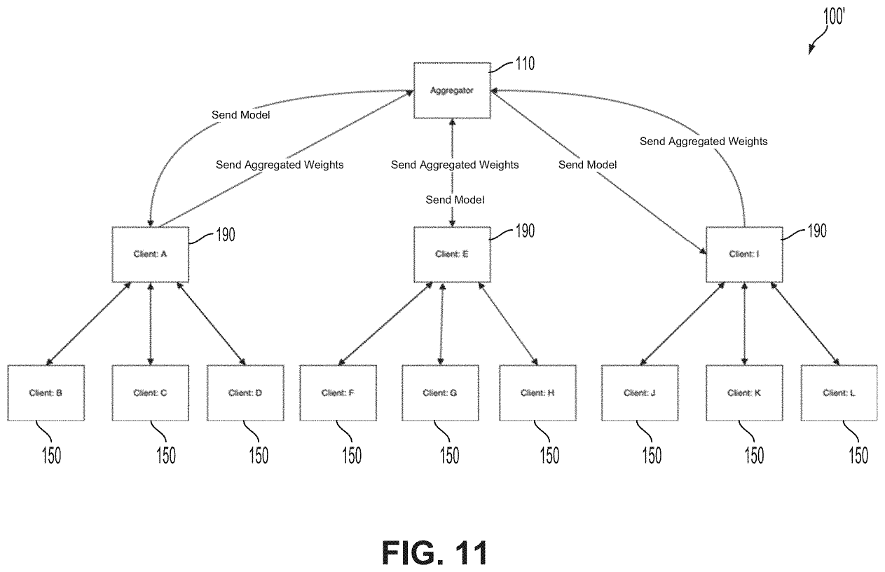

FIG. 11 shows an example architecture of a federated learning system 100′, in accordance with an embodiment. Federated learning system 100′ includes an aggregator node 110 and a plurality of client nodes 150. As depicted, federated learning system 100′ also includes a plurality of client nodes 190 serving as micro-aggregators, each of which may be referred to as a micro-aggregator node 190.

The example architecture of federated learning system 100′ is hierarchical in that aggregator node 110 communicates with micro-aggregator nodes 190, e.g., to provide model data, global model parameter updates, a public key, etc., and to receive local model updates therefrom. In turn, each micro-aggregator node 190 communicates with a subset of client nodes 150 and forward to such nodes model data, global model parameter updates, a public key, etc., received from aggregator node 110. Each micro-aggregator node 190 also receives local model updates generated at the subset of client nodes 150, and forwards such updates to aggregator node 110.

Each micro-aggregator node 190 and its subset of client nodes 150 may be referred to as a micro-hub. As depicted, a first micro-hub includes Client A serving as a micro-aggregator node 190 for a subset of client nodes 150, namely, Client B, Client C, and Client D; a second micro-hub includes Client E serving as a micro-aggregator node 190 for a subset of client nodes 150, namely, including Client F, Client G, and Client H; and a third micro-hub includes Client I serving as a micro-aggregator node 190 for a subset of client nodes 150, namely, including Client J, Client K, and Client L.

Aggregator node 110 delegates certain training coordination and aggregation functions to each micro-aggregator node 190, e.g., where such coordination and aggregation spans the micro-hub of each respective micro-aggregator node 190. So, for example, each micro-aggregator node 190 implements functionality of training coordinator 114 and global model trainer 118 for its micro-hub. For example, model parameter aggregation is performed at the level of client nodes 150 by respective micro-aggregator nodes 190. Then, model parameter aggregation is performed at the level of micro-aggregator nodes 190 by aggregator node 110. For example, micro-aggregator nodes 190 may pass a payload sequentially among themselves, with the last micro-aggregator node 190 in a training cycle providing the payload back to aggregator node 110. Each micro-aggregator node 190 may continue to function as a client node, e.g., including computing local model parameter updates based on training data available at the micro-aggregator node 190.

When training termination criteria are met, aggregator node 110 provides updated model parameters to each micro-aggregator node 190, which then provides those parameters to each client node 150 within its micro-hub.

The example architecture of federated learning system 100′ facilitates parallel training, e.g., across micro-hubs. The example architecture of federated learning system 100′ may be suitable when there are a large number of client nodes 150 (e.g., more than 10, more than 100, more than 1000, or the like).

Except as described above, federated learning system 100′ is otherwise substantially similar to federated learning system 100.

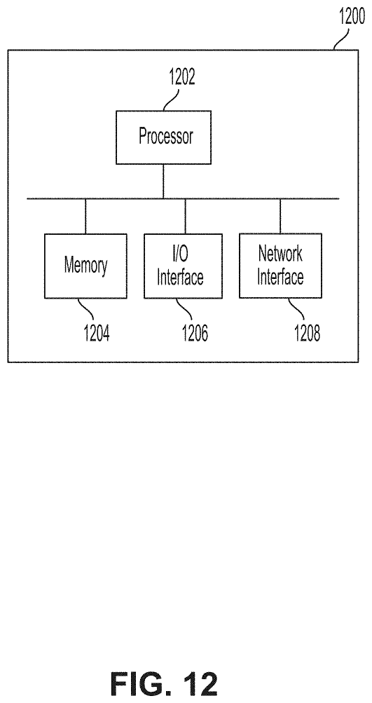

FIG. 12 is a schematic diagram of computing device 1200 which may be used to implement aggregator node 110, in accordance with an embodiment. Computing device 1200 which may also be used to one or more client nodes 150 or micro-aggregator nodes 190, in accordance with an embodiment.

As depicted, computing device 1200 includes at least one processor 1202, memory 1204, at least one I/O interface 1206, and at least one network interface 1208.

Each processor 1202 may be, for example, any type of general-purpose microprocessor or microcontroller, a digital signal processing (DSP) processor, an integrated circuit, a field programmable gate array (FPGA), a reconfigurable processor, a programmable read-only memory (PROM), or any combination thereof.

Memory 1204 may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like.

Each I/O interface 1206 enables computing device 1200 to interconnect with one or more input devices, such as a keyboard, mouse, camera, touch screen and a microphone, or with one or more output devices such as a display screen and a speaker.

Each network interface 1208 enables computing device 1200 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

For simplicity only, one computing device 1200 is shown but each node of system 100 may include multiple computing devices 1200. The computing devices 1200 may be the same or different types of devices. The computing devices 1200 may be connected in various ways including directly coupled, indirectly coupled via a network, and distributed over a wide geographic area and connected via a network (which may be referred to as “cloud computing”).

For example, and without limitation, a computing device 1200 may be a server, network appliance, set-top box, embedded device, computer expansion module, personal computer, laptop, personal data assistant, cellular telephone, smartphone device, UMPC tablets, video display terminal, gaming console, or any other computing device capable of being configured to carry out the methods described herein.

In some embodiments, a computing device 1200 may implement a trust organization server 10 or a blockchain device 20.

The foregoing discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements.

Of course, the above described embodiments are intended to be illustrative only and in no way limiting. The described embodiments are susceptible to many modifications of form, arrangement of parts, details and order of operation. The disclosure is intended to encompass all such modification within its scope, as defined by the claims.

What is claimed is:

1. A computer-implemented method for federated learning in a network of nodes, the method comprising:
at an aggregator node of the network of nodes:
generating a payload data structure defining initial parameter values of a model to be trained by way of federated learning;
identifying a target node from among a pool of nodes for receiving the payload data structure;
providing the payload data structure to the target node;
receiving an updated payload data structure from a node other than the target node, the payload data structure including locally trained model parameter values updated by a plurality of client nodes, the model parameter values encrypted using a public key of the aggregator node;
decrypting the locally trained model parameter values using a private key corresponding to the public key; and
generating global model parameter values based on the decrypted locally trained model parameter values.

2. The computer-implemented method of claim 1, further comprising:
at the aggregator node, providing data reflective of the model to at least one of the client nodes.

3. The computer-implemented method of claim 1, further comprising:
at the aggregator node, providing data reflective of the public key to at least one of the client nodes.

4. The computer-implemented method of claim 1, wherein at least one of said providing and said receiving is by way communication using a decentralized identifier.

5. The computer-implemented method of claim 4, wherein the communication implements DIDComm.

6. The computer-implemented method of claim 1, wherein at least one of said providing and said receiving is by way communication using a blockchain.

7. The computer-implemented method of claim 1, wherein the locally trained model parameter values are encrypted using homomorphic encryption.

8. The computer-implemented method of claim 7, wherein the homomorphic encryption includes Pallier encryption.

9. The computer-implemented method of claim 1, wherein said generating global model parameter values includes computing an average of the locally trained model parameter values.

10. The computer-implemented method of claim 1, wherein said target node is a micro-aggregator node.

11. An aggregator node in a federated learning network, the aggregator node comprising:
at least one processor;
memory in communication with the at least one processor, and software code stored in the memory, which when executed by the at least one processor causes the aggregator node to:
generate a payload data structure defining initial parameter values of a model to be trained by way of federated learning;
identify a target node from among a pool of nodes for receiving the payload data structure;
provide the payload data structure to the target node;
receive an updated payload data structure from a node other than the target node, the payload data structure including locally trained model parameter values updated by a plurality of client nodes, the model parameter values encrypted using a public key of the aggregator node;
decrypt the locally trained model parameter values using a private key corresponding to the public key; and
generate global model parameter values based on the decrypted locally trained model parameter values.

12. A computer-implemented method for federated learning in a network of nodes, the method comprising:
at a given client node of the network of nodes:
receiving a payload data structure including locally trained model parameter values updated by at least one other client node, the model parameter values encrypted by a public key of an aggregator node of the network of nodes;
performing local model training using training data available at the given client node to compute further model parameter values;
encrypting the further model parameter values using the public key;
updating the locally trained model parameter values to incorporate the further model parameter values; and
providing the updated model parameter values to another node of the network of nodes.

13. The computer-implemented method of claim 12, wherein at least one of said providing and said receiving is by way communication using a decentralized identifier.

14. The computer-implemented method of claim 13, wherein the communication implements DIDComm.

15. The computer-implemented method of claim 12, wherein at least one of said providing and said receiving is by way communication using a blockchain.

16. The computer-implemented method of claim 12, wherein said encrypting includes homomorphic encryption.

17. The computer-implemented method of claim 16, wherein the homomorphic encryption includes Pallier encryption.

18. The computer-implemented method of claim 12, further comprising, at the given client node, selecting the another node from a plurality of available nodes.

19. The computer-implemented method of claim 18, wherein said selecting includes randomly selecting.

20. A client node in a federated learning network, the client node comprising:
at least one processor;
memory in communication with the at least one processor, and software code stored in the memory, which when executed by the at least one processor causes the client node to:
receive a payload data structure including locally trained model parameter values updated by at least one other client node, the model parameter values encrypted by a public key of an aggregator node of the network of nodes;
perform local model training using training data available at the given client node to compute further model parameter values;
encrypt the further model parameter values using the public key;
update the locally trained model parameter values to incorporate the further model parameter values; and
provide the updated model parameter values to another node of the network of nodes.
